(19) United States
(12) Patent Application Publication
(10) Pub. No.: US 2026/0041228 A1
(43) Pub. Date: Feb. 12, 2026

(54) Go Compact Toothbrush with Floss

(71) Applicant: Maryam Ahmadi, Fremount, CA (US)

(72) Inventor: Maryam Ahmadi, Fremount, CA (US)

(21) Appl. No.: 19/252,972

(22) Filed: Jun. 27, 2025

Related U.S. Application Data
(60) Provisional application No. 63/680,938, filed on Aug. 8, 2024.

(51) Int. Cl. A46B 15/00; A46B 5/00; A46B 17/04; A46B 17/08; A61C 15/04

(52) U.S. Cl. CPC A46B 15/0069; A46B 5/0095; A46B 15/0065; A46B 17/04; A46B 17/08; A61C 15/043; A46B 2200/1066

(57) ABSTRACT

A compact toothbrush with a flossing mechanism designed to provide a unique solution for maintaining oral hygiene conveniently. The combination of a toothbrush and flossing mechanism in a single compact unit addresses the needs of busy individuals who require an easy and effective way to care for their teeth while on the move. The compact toothbrush is comprised of a detachable toothbrush head having standard bristles and a case, wherein the case functions as a handle for the detachable toothbrush when in use. When not in use, the detachable toothbrush is stored within the case. The case is ergonomically designed to have a comfortable grip. Additionally, the case includes ventilation holes to ensure that the toothbrush remains dry and hygienic when stored within the case.

### FIELD OF THE DISCLOSURE

The present invention relates generally to oral hygiene devices, specifically a compact toothbrush that incorporates a flossing feature within a case of the compact toothbrush.

### BACKGROUND OF THE INVENTION

People are constantly on the go and as such it is important to maintain oral hygiene while on the go. This invention aims to provide a convenient solution for individuals who need to floss and brush their teeth while traveling or during their daily routine.

An objective of the present invention is to provide a portable and convenient oral hygiene tool. It combines a detachable toothbrush and flossing mechanism in a single compact unit, making it ideal for travelers, professionals, and anyone with a busy lifestyle. The combination of a toothbrush and flossing mechanism in a single compact unit addresses the needs of busy individuals who require an easy and effective way to care for their teeth while on the move. The addition of ventilation holes ensures that the toothbrush remains dry and hygienic.

### SUMMARY OF THE INVENTION

The present invention is a compact toothbrush designed to be a portable and convenient oral hygiene tool. It combines a toothbrush and flossing mechanism in a single compact unit, making it ideal for travelers, professionals, and anyone with a busy lifestyle.

The present invention is comprised of a toothbrush component and a case integrated with a flossing mechanism. The toothbrush component is a detachable toothbrush head. The toothbrush head has a standard brush head with soft bristles designed for effective and gentle cleaning of teeth and gums. The case is ergonomically designed to provide a comfortable grip to a user of the compact toothbrush. The case includes a built-in floss dispenser, wherein floss is stored on a spool inside the case. The floss can be easily dispensed and cut to the desired length using a floss cutter also integrated into the case. The case also serves as a protective cover for the toothbrush head when the toothbrush head is stored inside the case, keeping the toothbrush head clean and hygienic when not in use. Ventilation holes within the case allow air to flow within the case when the toothbrush head is stored within, preventing moisture build-up and keeping the toothbrush head dry and hygienic. Thus, the present invention provides a unique solution for maintaining oral hygiene conveniently.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is a perspective view of the present invention.

FIG. 2 is a front view of an embodiment of the present invention.

FIG. 3 is left view of the present invention.

FIG. 4 is a back view of the present invention.

FIG. 5 is a top view of the present invention.

FIG. 6 is a bottom view of the present invention.

FIG. 7 is a perspective view displaying an interior of an embodiment of the present invention.

FIG. 8 is a right view displaying an interior of the present invention.

FIG. 9 is perspective view from bottom to top displaying an interior of an embodiment of the present invention.

FIG. 10 is a perspective view of the present invention.

FIG. 11 is a perspective view displaying an interior of an embodiment of the present invention.

All illustrations of the drawings are for the purpose of describing selected versions of the present invention and are not intended to limit the scope of the present invention.

### DETAILED DESCRIPTION

In the Summary of the Invention above, in this Detailed Description, in the Claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

The term “comprises”, and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “dorsal” refers to positions that are located near, on, or towards the upper or top side of a structure.

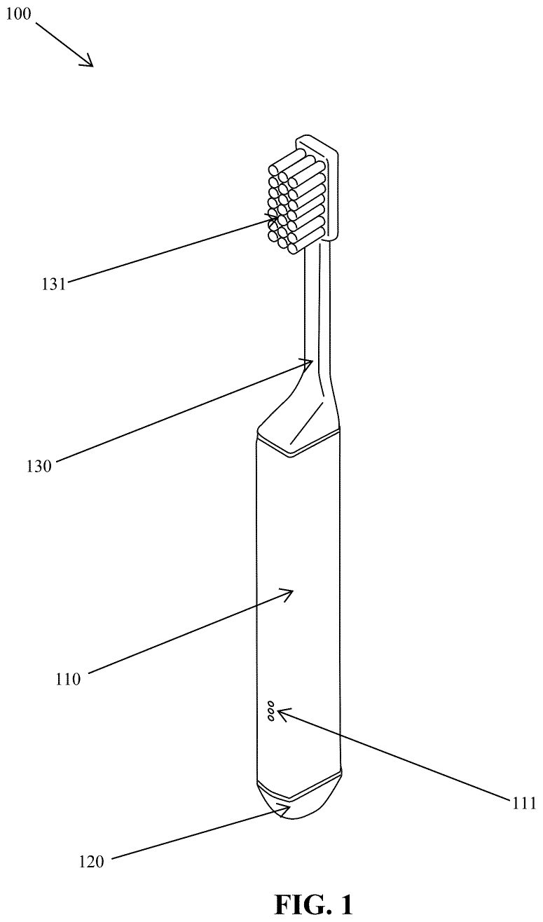

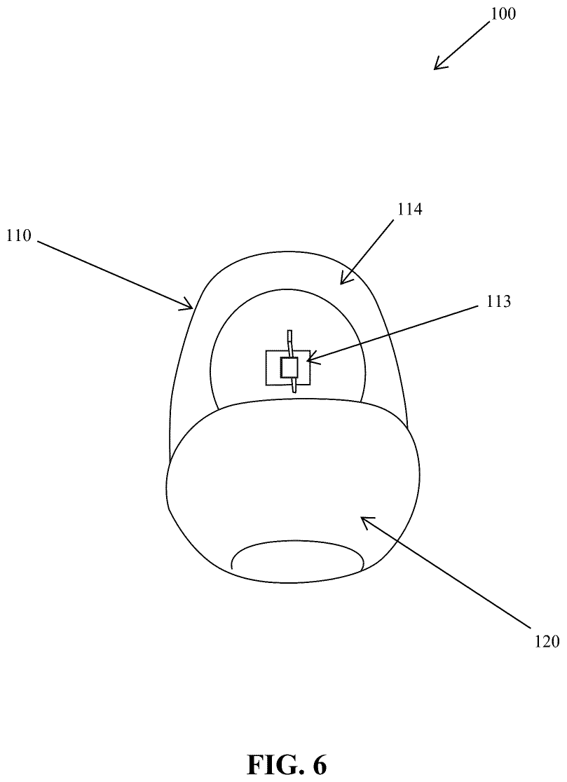

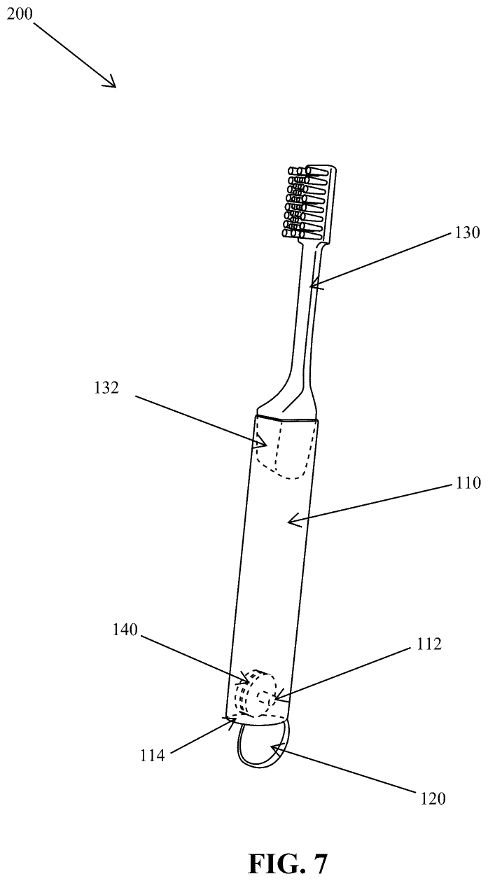

Referring to FIG. 1, FIG. 1 is a perspective view of the present invention a compact toothbrush with floss 100. The compact toothbrush with floss 100 is comprised of a case 110, a detachable toothbrush 130 having bristles 131, a floss 140 (See FIG. 7) wound around a spool 112 (See FIG. 7) attached within the case 110, a floss access lid 120, and a floss cutter 113 (See FIG. 6). The case 110 has an open end (not shown) which receives an adapter 132 (See FIG. 7) of the detachable toothbrush 130, and a closed end 114 (See FIG. 6), wherein the floss cutter 113 is integrated into. Additionally, the case 110 has ventilation holes 111 along a surface of the case 110.

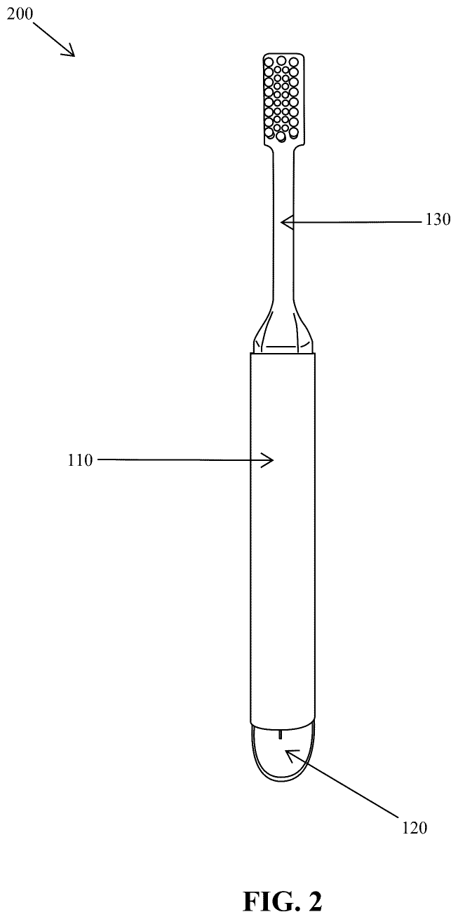

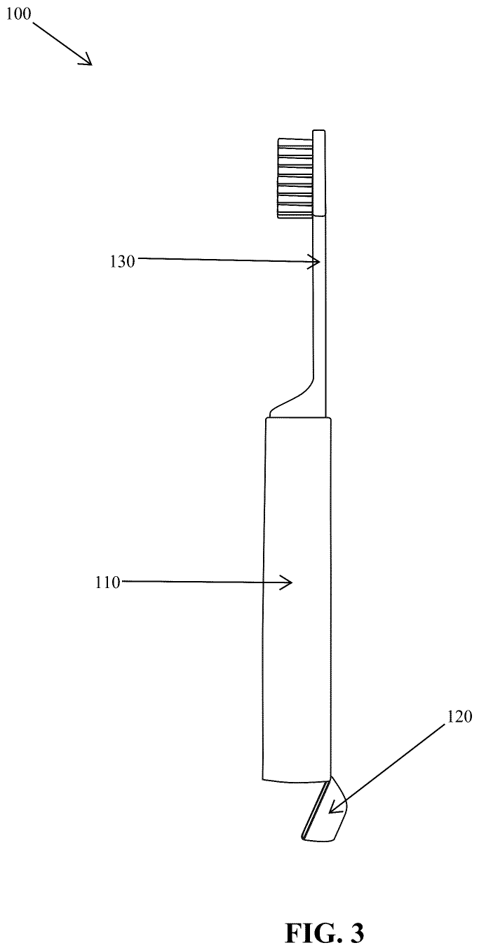

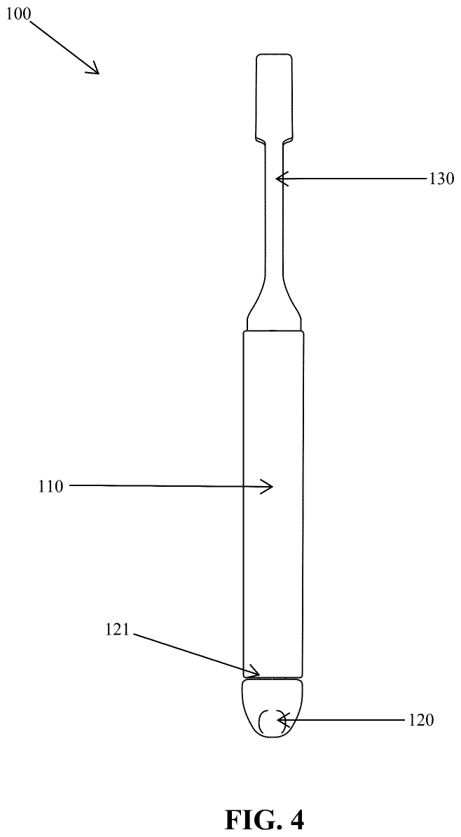

Referring to FIG. 2-6, FIG. 2 is a front view of an embodiment of the compact toothbrush with floss 100 with the floss access lid 120 in an open position. FIG. 3 is a left view of the compact toothbrush with floss 100 with the floss access lid 120 in an open position. FIG. 4 is a back view of the compact toothbrush with floss 100 with the floss access lid 120 in an open position displaying the hinge 121 that connects the floss access lid 120 to the case 110.

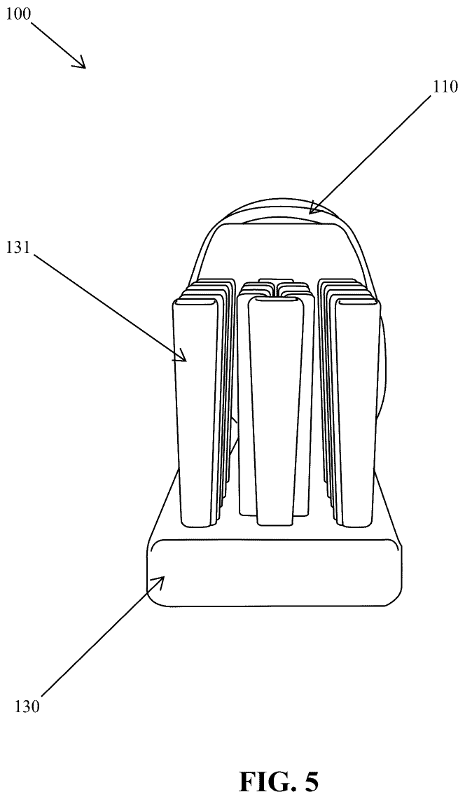

Referring to FIGS. 5 and 6, FIG. 5 is top view of the compact toothbrush with floss 100 displaying the bristles 131 of the detachable toothbrush 130. FIG. 6 is a bottom view of the compact toothbrush with floss 100 with the floss access lid 120 in an open position displaying the closed end 114 of the case 110, wherein the floss cutter 113 is integrated into the closed end 114 of the case 110.

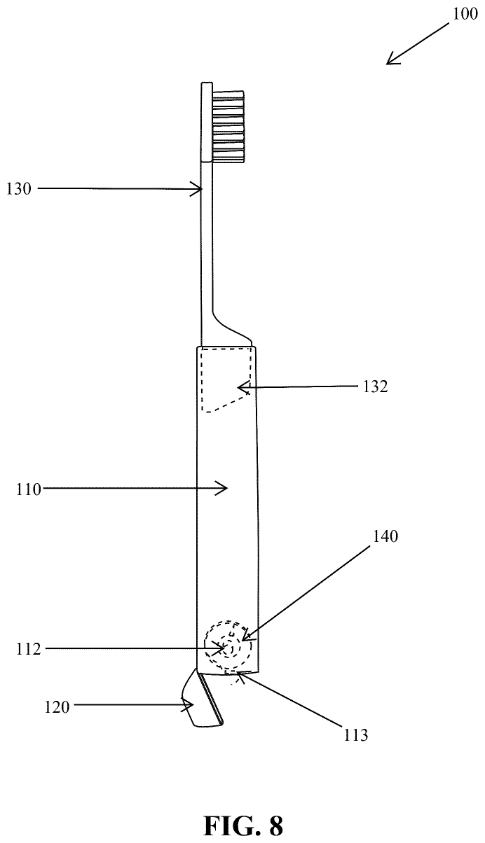

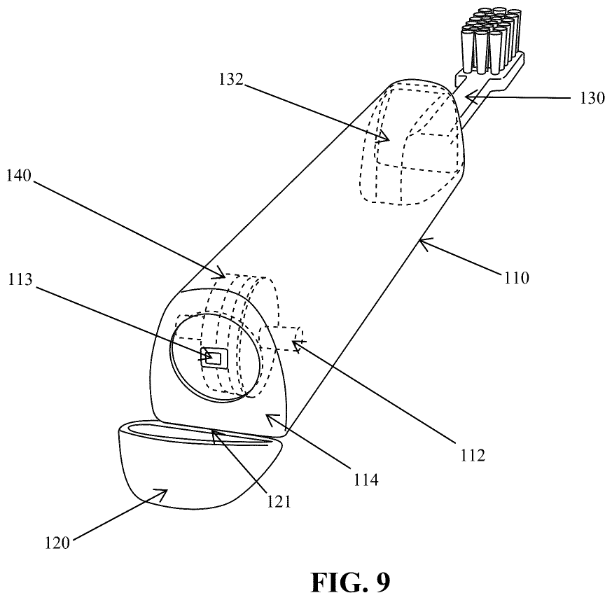

Referring to FIG. 7-9, FIG. 7 is a perspective view of an interior of an embodiment of the compact toothbrush with floss 100 with the floss access lid 120 in an open position. Displayed is an adapter 132 of the detachable toothbrush 130. The adapter 132 fits into the open end (not shown) of the case 110. Further displayed is the floss 140 wound around the spool 112 attached within the case 110. The floss 140 and spool 112 are located near the closed end 114 of the case 110 such that the floss 140 can be spooled through the floss cutter 113. FIG. 8 is a right view displaying the interior of the compact toothbrush with floss 100 with the floss access lid 120 in an open position. FIG. 9 is a perspective view from bottom to top displaying the interior of an embodiment of the compact toothbrush with floss 100 with the floss access lid 120 in an open position.

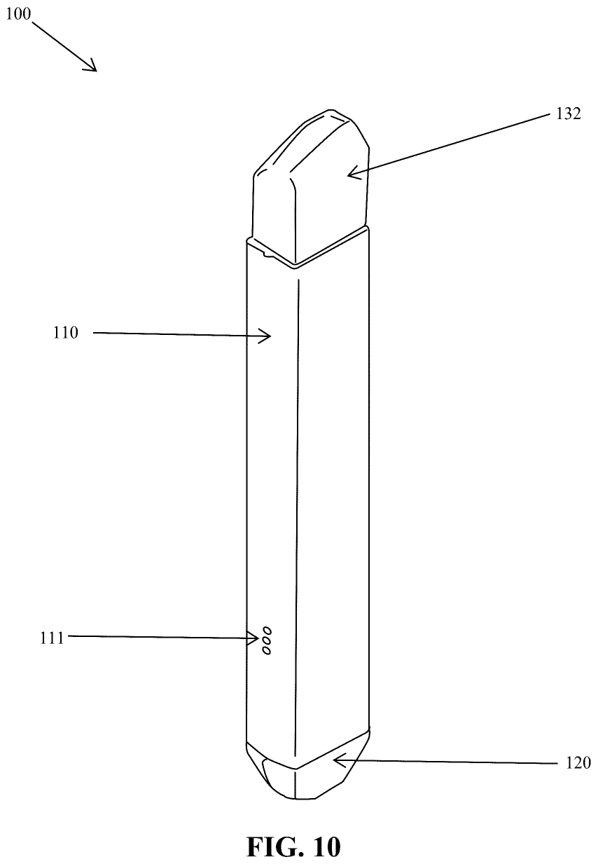

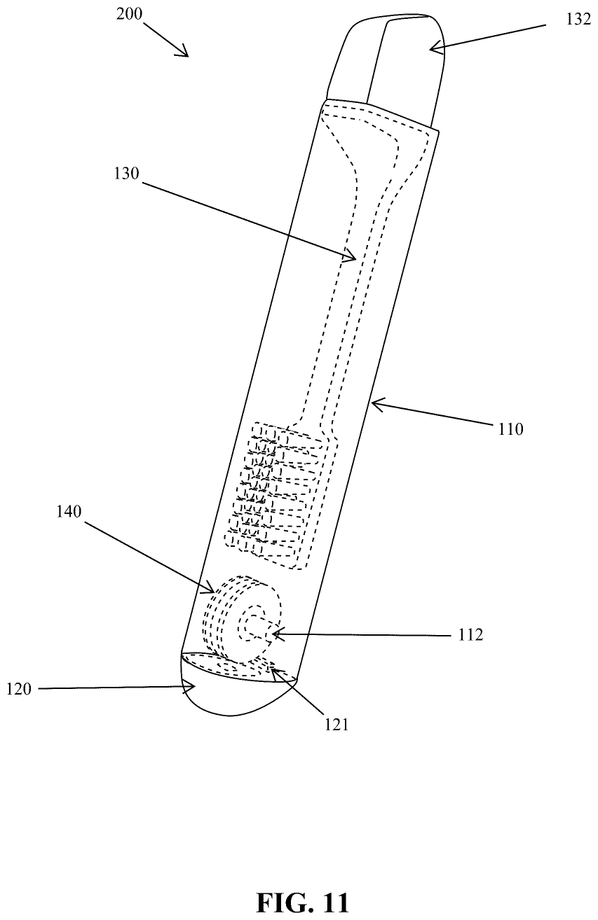

Referring to FIGS. 10 and 11, FIG. 10 is a perspective view of the compact toothbrush with floss 100 with the floss access lid 120 in a closed position and the detachable toothbrush 130 has been inserted into the case 110, wherein the adapter 132 of the detachable toothbrush 130 is exposed. FIG. 11 is a perspective view displaying the interior of the compact toothbrush with floss 100 with the floss access lid 120 in a closed position and the detachable toothbrush 130 has been inserted into the case 110, wherein the adapter 132 of the detachable toothbrush 130 is exposed. The adapter 132 is designed so as to prevent the detachable toothbrush 130 from coming in contact with the floss 140 at the closed end of the case 110 when the detachable toothbrush is inserted into the case 110.

The present description includes one or more non-limiting embodiments of a compact toothbrush with floss. The compact toothbrush with floss is comprised of a case, a detachable toothbrush, a floss wound around a spool attached within the case, a floss access lid, and a floss cutter. The detachable toothbrush is a standard brush head with soft bristles designed for effective and gentle cleaning of teeth and gums. When not in use the detachable toothbrush is stored within the case. The case that also functions as a handle for the detachable toothbrush. When the detachable toothbrush is set for use an adapter at an end of the detachable toothbrush opposite of the toothbrush head is inserted into the case wherein a user grasps the case to use the compact toothbrush.

The case has an open end which receives the adapter of the detachable toothbrush, and a closed end wherein the floss cutter is integrated into. Additionally, the case has ventilation holes along a surface of the case. The case is designed to be ergonomical, providing a comfortable grip to a user. The ventilation holes facilitate airflow within the case, preventing moisture build-up inside the case and keeping the detachable toothbrush dry.

Additionally, the case also serves as a protective cover for the detachable toothbrush head when the detachable toothbrush is inserted into the case, wherein it keeps the toothbrush head bristles clean and hygienic when the detachable toothbrush is not in use.

Near the closed end of the case is a flossing mechanism. The flossing mechanism is comprised of the floss wound around the spool which is integrated into the case. Attached to closed end of the case is the floss access lid. The floss access lid is attached to the case via a hinge mechanism. The user can access the floss when the floss access lid is opened. Additionally, a floss cutter is integrated into the closed end of the case. When the floss access lid is opened the floss can be easily dispensed from the spool through the floss cutter wherein the floss is cut to a desired length.

Although the invention has been explained in relation to its preferred embodiment, it is to be understood that many other possible modifications and variations can be made without departing from the spirit and scope of the invention.

What is claimed is:

1. A compact toothbrush comprised of:
a detachable toothbrush having a brush head comprised of bristles at a first end and an adapter at a second end;
a case having an open end to receive the adapter of the detachable toothbrush, and a closed end;
a floss wound around a spool, wherein the spool of floss is attached within the case;
a floss cutter integrated into the closed end of the case; and
a floss access lid attached to the case, wherein the floss access lid has a closed position and an open position.

2. The compact toothbrush of claim 1, wherein the bristles of the detachable toothbrush are soft, medium, or hard in texture.

3. The compact toothbrush of claim 2, wherein the brush head of the detachable toothbrush is inserted into the open end of the case when the compact toothbrush is in a closed position, and the adapter of the detachable toothbrush is inserted into the open end of the case when the compact toothbrush is in an open position.

4. The compact toothbrush of claim 1, wherein one ventilation hole is located along an outer surface of the case.

5. The compact toothbrush of claim 1, wherein a plurality of ventilation holes are located along the outer surface of the case.

6. The compact toothbrush of claim 1, wherein the spool of floss is positioned near the closed end of the case.

7. The compact toothbrush of claim 6, wherein the floss is dispensed through the floss cutter integrated into the closed end of the case.

8. The compact toothbrush of claim 7, wherein the floss access lid is attached at the closed end of the case via a hinge mechanism.

9. The compact toothbrush of claim 8, wherein the floss access lid provides access to the floss dispensed through the floss cutter when the floss access lid is in an open position.

10. A compact toothbrush comprised of a detachable toothbrush having a brush head comprised of bristles at a first end and an adapter at a second end; a case having an open end, a closed end, and an outer surface, wherein at least on ventilation hole is located along the outer surface; a floss wound around a spool, wherein the spool is attached within the case; a floss cutter integrated into the closed end of the case; and a floss access lid attached to the case, wherein the floss access lid has a closed position and an open position.

11. The compact toothbrush of claim 10, wherein the bristles of the detachable toothbrush are soft, medium, or hard in texture.

12. The compact toothbrush of claim 11, wherein the brush head of the detachable toothbrush is inserted into the open end of the case when the compact toothbrush is in a closed position, and the adapter of the detachable toothbrush is inserted into the open end of the case when the compact toothbrush is in an open position.

13. The compact toothbrush of claim 10, wherein a plurality of ventilation holes are located along the outer surface of the case.

14. The compact toothbrush of claim 10, wherein the spool of floss is positioned near the closed end of the case.

15. The compact toothbrush of claim 14, wherein the floss is dispensed through the floss cutter integrated into the closed end of the case.

16. The compact toothbrush of claim 15, wherein the floss access lid is attached at the closed end of the case via a hinge mechanism.

17. The compact toothbrush of claim 16, wherein the floss access lid provides access to the floss dispensed through the floss cutter when the floss access lid is in an open position.

18. A compact toothbrush comprised of a detachable toothbrush having a brush head comprised of bristles at a first end and an adapter at a second end; a case having an open end, a closed end, and an outer surface, wherein at least on ventilation hole is located along the outer surface; a floss wound around a spool, wherein the spool is attached within the case positioned near the closed end of the case; a floss cutter integrated into the closed end of the case, wherein the floss is dispensed through the floss cutter; and a floss access lid attached to the case, wherein the floss access lid has a closed position and an open position, wherein the floss access lid provides access to the floss dispensed through the floss cutter when the floss access lid is in an open position.

19. The compact toothbrush of claim 18, wherein the brush head of the detachable toothbrush is inserted into the open end of the case when the compact toothbrush is in a closed position, and the adapter of the detachable toothbrush is inserted into the open end of the case when the compact toothbrush is in an open position.

20. The compact toothbrush of claim 19, wherein a plurality of ventilation holes are located along the outer surface of the case.
